(19) United States
(12) Patent Application Publication
(10) Pub. No.: US 2004/0080430 A1
(43) Pub. Date: Apr. 29, 2004

(54) Method and system for delivering location dependent severe weather information

(76) Inventor: Matt C. Videtich, Farmington Hills, MI (US)

Correspondence Address: ANTHONY LUKE SIMON, General Motors Corporation, Legal Staff, Mail Code 482-C23-B21, P.O. Box 300, Detroit, MI, 48265-3000, US

(21) Appl. No.: 10/281,699

(22) Filed: Oct. 28, 2002

(51) Int. Cl. G08G 1/09

(52) U.S. Cl. 340/905

(57) ABSTRACT

A method of delivering location dependent severe weather information is disclosed. A mobile unit receives broadcast severe weather information and a location signal indicative of a current location of the mobile unit. In response, location specific severe weather information is determined and an indication of the location specific severe weather information is provided.

### FIELD OF THE INVENTION

This invention relates to a method and system for delivering location dependent severe weather information.

### BACKGROUND OF THE INVENTION

Severe weather information is provided by the National Weather Service and is available to the general public via AM or FM radio stations or by NOAA (National Oceanic and Atmospheric Administration) weather radio receivers. For vehicle occupants, this information is not available if the vehicle is not equipped with an AM or FM radio or a weather radio receiver, or if the AM or FM radio is switched off or the weather radio receiver is disabled. Also, the severe weather information received may not be relevant to the occupants of the vehicle, since the vehicle may be outside of the affected area.

### SUMMARY OF THE INVENTION

Advantageously, this invention provides a method and system for delivering location dependent severe weather information.

Advantageously, according to a preferred example, this invention provides a method of delivering location dependent severe weather information, comprising: receiving in a mobile unit broadcast severe weather information; receiving a location signal indicative of a current location of the mobile unit; responsive to the location signal and the broadcast severe weather information, determining location specific severe weather information; and providing an indication of the location specific severe weather information.

Advantageously, according to another preferred example, this invention provides a system for delivering location dependent severe weather information, comprising: a satellite radio receiver receiving broadcast severe weather data containing at least one location dependent data record; a position signal providing position data describing a position of the satellite receiver; a monitor comparing the position data to a geographic boundary correlating to the location dependent data record; a display, responsive to the monitor, presenting information regarding severe weather at the position of the satellite receiver.

### BRIEF DESCRIPTION OF THE DRAWINGS

FIG. 1 is a schematic diagram of a system for delivering and receiving severe weather information in accordance with an example of the present invention.

FIG. 2 is a flow chart of a system for delivering, receiving, and presenting severe weather information in accordance with an example of the present invention.

FIG. 3 is a flow chart of a system for providing additional information delivering, receiving, and presenting severe weather information in accordance with an example of the present invention.

FIG. 4 is a schematic diagram of an information packet structure for delivering severe weather information in accordance with an example of the present invention.

FIG. 5 is a schematic diagram of a set of data packets containing severe weather information broadcast from a satellite in accordance with an example of the present invention.

### DETAILED DESCRIPTION OF A PREFERRED EMBODIMENT

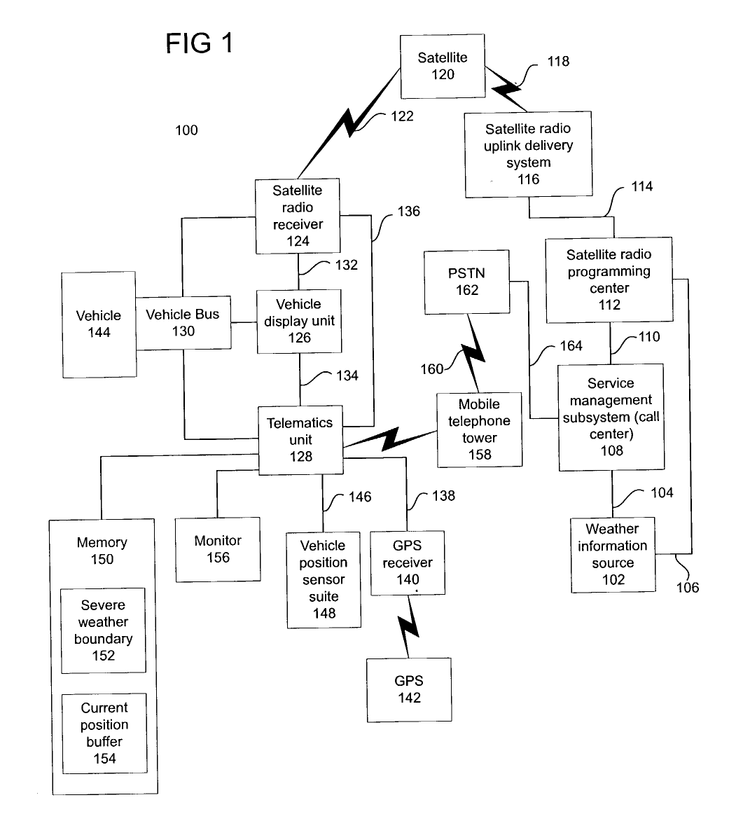

FIG. 1 illustrates an example system according to the present invention at 100, including a vehicle 144 that contains a vehicle bus 130, a satellite radio receiver 124, a vehicle display unit 126, and a telematics unit 128. The weather information source 102 may be the NOAA (National Oceanic and Atmospheric Administration), the IWIN (Interactive Weather Information Network), or other public or private weather information provider.

The weather information source 102 transmits severe weather information via a wireless or landline communications link 104 to a service management subsystem 108. The service management subsystem 108 is also referred to as a call center. Additionally, the weather information source 102 may transmit severe weather data information directly to a satellite radio programming center 112 via a wireless or land-line communication link 106. The service management subsystem 108 may retain or re-format the received severe weather data and may transmit the data to a satellite radio programming center 112 via a wireless or land-line communication link 110.

In an example implementation, the satellite radio programming center 112 re-formats the received severe weather data in preparation for transmission to a satellite radio up-link delivery system 116 via a wireless or land-line communication link 114. The satellite radio programming center transmits or uplinks the formatted weather data to a plurality of satellites 120 via methods 118 well known by practitioners in the art. The satellite 120 broadcasts 122 the severe weather information to a plurality or satellite radio receivers 124, either directly or via land-based repeaters. The example satellite radio receiver 124 is located within a vehicle 144 equipped with a vehicle bus 130.

The system may transmit the severe weather information continuously, or periodically. The choice is up to the system designer balancing the needs to preserve bandwidth for other uses and the desire to update the information for users. Additionally, updates may be triggered by changes in severe weather information from the weather information source 102.

The vehicle bus 130 enables communication between electronic devices within the vehicle 144, including the satellite radio receiver 124, the vehicle display unit 126, and the telematics unit 128. The satellite radio receiver 124 may communicate with the vehicle display unit 126 via a direct connection 132 and the telematics unit 128 via a direct connection 136. The vehicle display unit 126 may directly communicate with the satellite radio receiver 124 via a direct connection 132 and the telematics unit 128 via a direct connection 134. The telematics unit 128 may communicate with the vehicle display unit 126 via a direct connection 134 and the satellite radio receiver 124 via a direct connection 136. In this example, the satellite radio receiver 124, vehicle display unit 126, telematics unit 128, GPS receiver 140, and vehicle sensor suite 148, are located within the vehicle 144.

The weather information received is stored in the severe weather boundary data structure 152 within the memory 150 coupled to the telematics unit 128. The weather information contains the descriptions of the severe weather bounded by geographic coordinates, preferably consistent with the format supplied by the IWIN (Interactive Weather Information Network).

The vehicle telematics unit 128 communicates with a GPS (Global Positioning System) receiver 140 via a communications link 138 and may alternatively communicate with a vehicle position sensor suite 148 via a communications link 146. The GPS receiver 140 and the vehicle position sensor suite 148 may contain positional sensors and transducers of any type known to those skilled in the art. Example sensors and transducers include gyroscopes, accelerometers, magnetic direction sensing devices, and odometer-pulse information. The GPS receiver 140 accepts signals from the GPS satellite constellation 142. The signals are transformed by the GPS receiver 140 into the receiver's current geographical position. The current geographical position information is transferred to the telematics unit 128 via a communications link 138. The current geographical position is stored in the current position buffer 154 in the memory 150 coupled to the telematics unit 128 and is updated periodically by the GPS receiver 140 or the vehicle position sensor suite 148.

The telematics unit 128 constructs one or more geographic boundaries containing the severe weather information received by the satellite radio receiver 124 and places the geographic boundaries and weather information in the severe weather boundary 154 data structure in the memory 150 coupled to the telematics unit 128.

The current position in the current position buffer 154 is compared with the constructed geographic boundaries in the severe weather boundary data structure 152 by a software monitor 156. If the current position stored in the current position buffer 154 is within at least one of the geographic boundaries containing the severe weather, then a notice is issued to the vehicle display unit 126 via a direct communications link 134 or the vehicle bus 130. The signal issued to the vehicle display unit 126 provides textural warning types preferably consistent with the IWIN National Warning Areas categories, may be rendered as speech output, and/or may be a non-speech audio alarm. The IWIN National Warning Area categories are tornado, hurricane, sever thunderstorm, flash flood, flood, nonprecipitation, winter storm, and special marine. The text within these categories may consist of a warning describing the type of sever weather, the predicted time when the warning will expire, detailed text describing the severe weather, the estimated time of arrival where the severe weather will traverse, and the severe weather characteristics, such as prediction of damage and action to be taken by the individuals within the severe weather area. Latitude and longitude data describing the affected area (such as in the form of a parallelogram), may also be provided.

The indication or display signal is formatted by the telematics unit 128, and issued to the vehicle display unit 126 via the vehicle bus 130 or by the direct connection 134. Visual indications are sent periodically to the display unit 126 in pre-determined intervals. The intervals may be downloaded by the service management subsystem 108 via a link 164 to the PSTN (Public Service Telephone Network) 162, then transmitted wirelessly 160 to a mobile telephone tower 158 to the telematics unit 128. The intervals may alternatively be programmed directly into the telematics unit by a telematics service subscriber, or be retained in a telematics service subscriber profile at the service management subsystem 108 for download to the telematics unit 128 at an appropriate time.

If a telematics service subscriber requires additional information during the period when the severe weather alert is active, the phone number of the service management subsystem 108 is displayed for the subscriber to call. The telematics unit 128 may be alternatively enabled to automatically call the service management subsystem 108 for additional severe weather information and for any recommended subscriber action.

If the vehicle 144 exits the severe weather area by determining if the current vehicle position is outside of the constructed geographic boundary, then an ‘all clear’ message is issued to the vehicle display unit 126 by the telematics unit 128 or the satellite radio receiver 124.

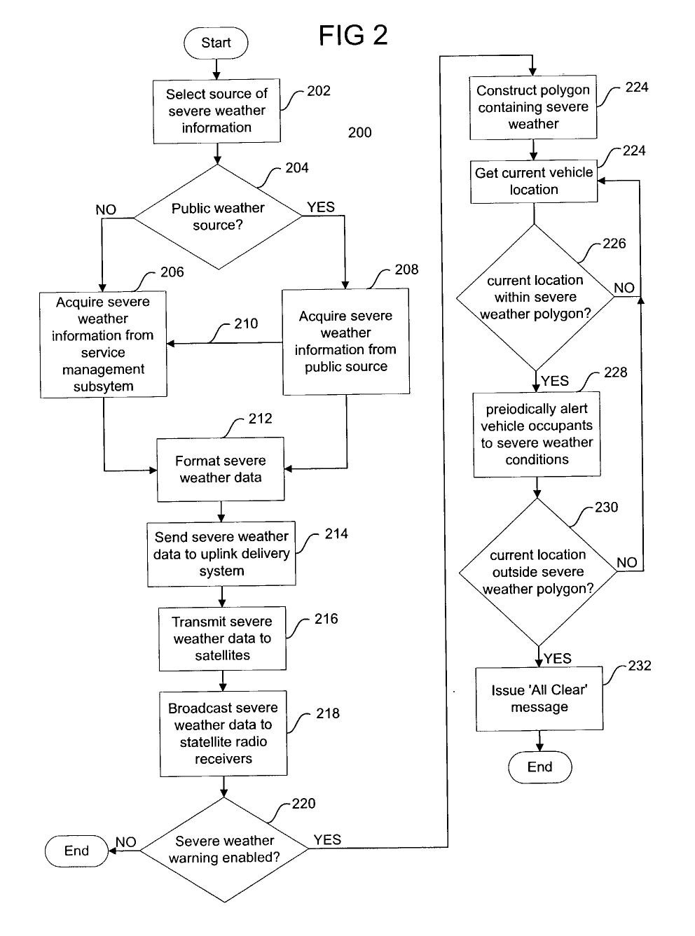

FIG. 2 provides a flow chart of a system for delivering, receiving, and presenting severe weather information in accordance with an example of the present invention at 200. A satellite radio programming center 202 selects a source of severe weather information 204. The source of severe weather-information may be public source of severe weather information, such as IWIN, or may be a private source of severe weather information, such as a service management subsystem. After the selection is made, the satellite radio programming center acquires severe weather information from the service management subsystem 206 or the public source 208. The service management subsystem 206 may also directly receive severe weather 210 data from a public source 208, such as IWIN (Interactive Weather Information Network).

The severe weather data is placed in a format 212 compatible with that required by the satellite radio uplink delivery system (120, FIG. 1) and then transmitted to the satellite uplink delivery system 214. The severe weather data is then transmitted to the satellites 216 for broadcast to satellite radio receivers 218 (either directly or through land-based repeaters as is known in the art). Within a satellite radio receiver, a preset value indicating whether severe weather warnings are enabled is examined 220. If severe weather warnings are enabled 220 within a vehicle containing a satellite radio receiver (112, FIG. 1), then the data received by the satellite radio receiver is stored and one or more polygons are constructed from the severe weather positional data 222, typically latitude and longitude values.

The current vehicle location 224 is retrieved compared with the polygons constructed containing the severe weather 226. If the vehicle position is within one of the polygons containing the severe weather 226, then a periodic alert is issued to the vehicle occupants advising them of severe weather conditions 228. The periodicity of the alert may be pre-programmed in the vehicle telematics unit (128, FIG. 1) or may be manually programmed by the telematics unit user. If the vehicle is not within a polygon containing the severe weather 226, then the current vehicle position is retrieved 224 to monitor vehicle position with respect to the constructed polygons containing the severe weather 222.

If the current vehicle location is outside of a severe weather polygon 230 after being within the severe weather polygon, then an ‘All Clear’ message 232 is issued to the vehicle display unit (126, FIG. 1). If the current vehicle location is still within a polygon containing the severe weather 230, then the current vehicle position is retrieved 224 to monitor vehicle position with respect to the respective polygon containing the severe weather 222.

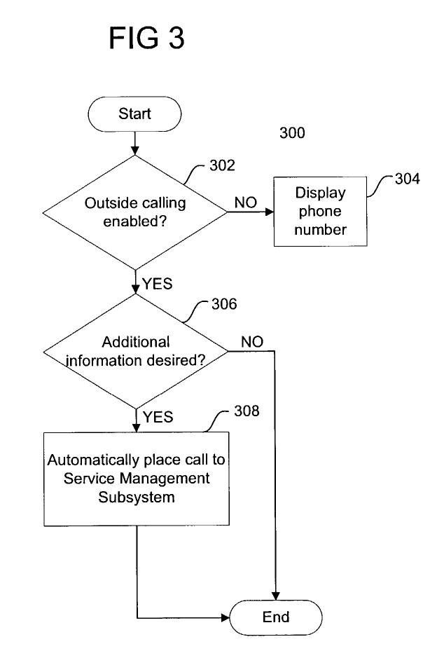

FIG. 3 provides a flow chart of an example method for providing additional information for delivering, receiving, and presenting severe weather information in accordance with the present invention at 300. If a vehicle is within a constructed polygon containing severe weather, then the monitor (156, FIG. 1) determines if outside calling is enabled 302. Outside calling capability is resident within telematics unit (128, FIG. 1) that allows the telematics unit (128, FIG. 1) to place a call to the mobile telephone tower (158 FIG. 1), through the PSTN (162, FIG. 1) and ultimately connecting at the service management subsystem (108, FIG. 1). If outside calling is not enabled 302 then a phone number to call 304 is displayed on the vehicle display unit (126, FIG. 1). This number may be the service management subsystem (108, FIG. 1), the weather information source (102, FIG. 1), or other public or private facility. If outside calling is enabled 302 then the vehicle occupants are prompted via the vehicle display unit (126, FIG. 1) inquiring whether additional information is desired 306. If no additional information is desired, then the session is terminated. If additional information is desired 306, then the telematics unit (128, FIG. 1) places a call 308 to the service management subsystem (108, FIG. 1).

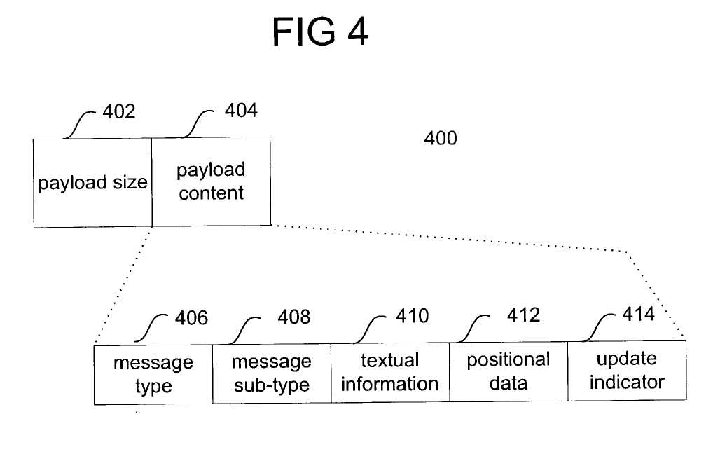

FIG. 4 provides an example information packet containing severe weather information in accordance with the present invention at 400. A data information packet consists of two components; a payload size 402 component and a payload content 404 component. The payload size 402 component contains the overall size in bytes of the data information packet. The payload content 404 component is further subdivided into sub-components. The sub-components are message type 406, message sub-type 408, textual information 410, positional data 412, and an update indicator 414.

The message type 406 indicates weather information context, as opposed to other types of information, such as stock reports or news. The message type may be an integer, character, or bit indicator. A message type of the integer ‘1’ or the character ‘A’, or a bit at a specified position within this component may indicate weather information context for the remainder of the information packet.

The message sub-type 408 contains the type of weather event. This message sub-type may be an integer, character, or bit indicator. A message type of the integer ‘1’ or the character ‘A’, or a bit at a specified position within this component may indicate a severe thunderstorm or tornado weather sub-type.

The textual information 410 contains text information describing the weather event identified within the message sub-type 408 information packet component. This text may be consistent with the IWIN format which contains the severe weather warning itself, an expiration time when the severe weather will terminate, detailed information regarding the severe weather, the estimated time of arrival to areas in the path of the severe weather, and the characteristics of the severe weather including recommendations for action.

The positional data describing the polygon of the geographic area affected by the severe weather is contained in the positional data 412 component. An update indicator 414 specifies whether the data in the information packet has changed since the last information packet transmission. The integer ‘1’, or the character ‘A’, or a bit at a specified location in the update indicator 414 may specify whether the data is new and different from the previously transmitted information packet. The integer ‘0’, the character ‘B’, or a bit a specified location in the update indicator 414 may specify whether the data is unchanged from the previously transmitted information packet.

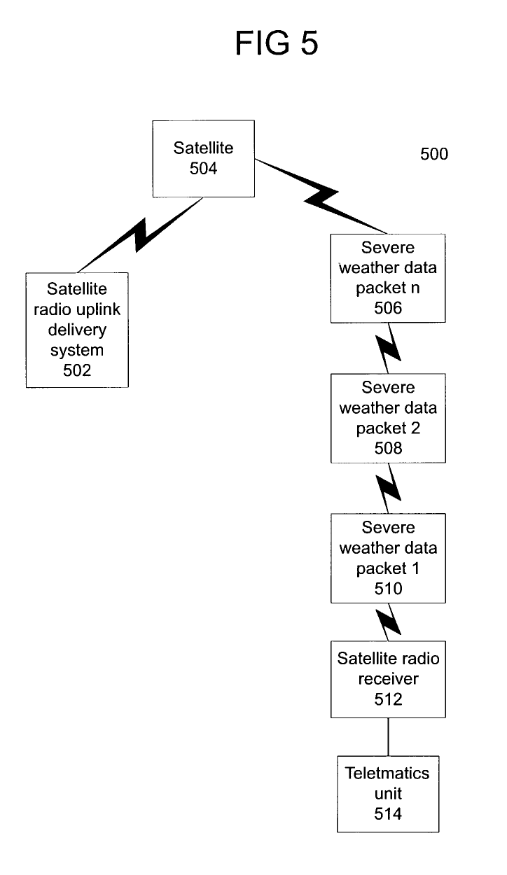

FIG. 5 is a schematic diagram of a set of data packets containing severe weather information broadcast from a satellite in accordance with the present invention at 500. Severe weather data is transmitted from a satellite radio uplink delivery system 502 to a plurality of satellites 504. The satellites 504 broadcast a plurality of severe weather data packets; severe weather data packet 1, packet 2, through packet n, blocks 510, 508 and 506, respectively. Each of the severe weather data packets contains specific severe weather information (FIG. 4, 410) and positional data (FIG. 4, 412) describing a polygon of the geographic area affected by the severe weather.

A satellite radio receiver 512 receives the severe weather data packet 510 and transfers the packet to a telematics unit 514. The telematics unit 514 preferably performs a selection of relevant data packets so it is monitoring only those likely to affect the vehicle. In one example, unit 514 constructs a polygon from each data packet of the positional data (FIG. 4, 412) received. The current position of the telematics unit 514 is compared to the area within each constructed polygon. If the current position of the telematics unit 514 is within the area inscribed by the constructed polygon, the severe weather data packet 510 is accepted for further processing. If the current position of the telematics unit 514 is outside of the constructed polygon, the severe weather data packet 510 is rejected. No further processing is necessary to the rejected severe weather data packet 510. This method is repeated for the severe weather data packets 2, 508, through severe weather data packets n, 506.

In the above described example, the satellite radio receiver 124, is located in a vehicle with a telematics unit, and GPS receiver. As will be apparent to those skilled in the art, this invention is equally applicable to satellite receivers not located in vehicles, in which case the memory and processing functions are carried out by the satellite receiver unit (or some other accessory component) and position determination may be an integrated GPS unit or another type of system for obtaining position information (such as a wireless analog or digital telephone receiver) suitable for use in determining whether a user is in a severe weather area.

1. A method of delivering location dependent severe weather information, comprising:
a) receiving in a mobile unit broadcast severe weather information;
b) receiving a location signal indicative of a current location of the mobile unit;
c) responsive to the location signal and the broadcast severe weather information, determining location specific severe weather information; and
d) providing an indication of the location specific severe weather information.

2. The method of claim 1 wherein:
the broadcast severe weather information contains a plurality of broadcast weather information packets, and wherein an individual packet of the packets contains severe weather information for a distinct geographic area.

3. The method of claim 1 wherein:
the broadcast severe weather information contains a plurality of broadcast weather information packets, and wherein an individual packet of the plurality of packets contains the location specific severe weather information.

4. The method of claim 2, additionally comprising the steps of:
constructing a first polygon describing a geographic boundary around the mobile unit;
selecting from the plurality of broadcast severe weather information packets one or more packets having a location designation common to the first polygon, wherein the location specific severe weather data is the broadcast severe weather information contained in the one or more packets having the location designation common to the first polygon.

5. The method of claim 1, also comprising:
indicating when a telematics unit enters an area that contains severe weather;
indicating when a telematics unit is within the area that contains severe weather; and
indicating when a telematics unit is outside of the area that contains severe weather.

6. A system for delivering location dependent severe weather information, comprising:
a satellite radio receiver receiving broadcast severe weather data containing at least one location dependent data record;
a position signal providing position data describing a position of the satellite receiver;
a monitor comparing the position data to a geographic boundary correlating to the location dependent data record;
a display, responsive to the monitor, presenting information regarding severe weather at the position of the satellite receiver.

7. A method for delivering location dependent severe weather information, comprising the steps of:
a) receiving in a mobile unit weather information describing weather;
b) receiving geographic boundary data relating to the weather information;
c) determining a location of the mobile unit;
d) comparing the location of the mobile unit to the geographic boundary data; and
e) providing an indication of the location of the mobile unit with respect to the geographic boundary data, wherein the user is informed when the mobile unit is within an area affected by severe weather.
